(19) United States
(12) Patent Application Publication
(10) Pub. No.: US 2023/0389139 A1
(43) Pub. Date: Nov. 30, 2023

(54) Induction Cooktop Comprising A Support Structure Having Antennas And/Or Sensors, Method For Producing A Support Structure Of This Kind, And Use Of A Support Structure For An Induction Cooktop

(71) Applicant: E.G.O. Elektro-Geraetebau GmbH, Oberderdingen (DE)

(72) Inventors: Christian Egenter, Bretten (DE); Ulrich Waechter, Bruchsal (DE); Max-Felix Mueller, Oberderdingen (DE); Mathias Bellm, Ubstadt-Weiher (DE); Michael Rupp, Eppingen (DE)

(21) Appl. No.: 18/323,519

(22) Filed: May 25, 2023

(30) Foreign Application Priority Data
May 30, 2022 (DE) 10 2022 205 386.9

(51) Int. Cl. H05B 6/12; H01Q 1/22; G01V 11/00

(52) U.S. Cl. CPC H05B 6/1209; H01Q 1/22; G01V 11/002

(57) ABSTRACT

An induction cooktop comprising a cooktop plate and a planar and flat support structure has a flexible woven fabric as a support on which antennas and/or sensors are mounted as lines by means of embroidering processes. The antennas and/or sensors have feed lines, which are mounted and/or secured on the support by means of embroidering processes and cross one another and other lines on the same surface of the support, wherein they are electrically insulated from one another. The support structure has a thermal stability of ≥200° C. It is arranged on a planar and flat retainer and, together with antennas and/or sensors, is pressed against an underside of the cooktop plate by said retainer.

### CROSS-REFERENCE TO RELATED APPLICATIONS

This application claims priority to German Application No. 10 2022 205 386.9, filed May 30, 2022, the contents of which are hereby incorporated herein in its entirety by reference.

### FIELD OF APPLICATION AND PRIOR ART

The invention relates to an induction cooktop comprising a support structure having antennas and/or sensors, to a method for producing a support structure of this kind, and to a use of a support structure for an induction cooktop.

Using an induction cooktop for wirelessly transmitting energy toward an electrical load by means of inductive coupling is known from US 2022/255355 A1. This form of wireless energy transmission is also referred to as Wireless Power Transfer, WPT.

### PROBLEM AND SOLUTION

The problem addressed by the invention is to provide an induction cooktop of the kind mentioned at the outset comprising a support structure having antennas and/or sensors, a method for producing a support structure of this kind, and a use of a support structure of this kind for an induction cooktop of this kind, by which issues from the prior art can be overcome and which in particular make it possible to operate and control an induction cooktop safely and practically with the highest possible operating safety and the highest possible operating convenience, in particular for operating an electrical load on the induction cooktop by wirelessly transmitting energy from the induction cooktop to the load.

This problem is solved by an induction cooktop having the features of claim 1, by a method having the features of claim 21, and by a use of a support structure for an induction cooktop having the features of claim 26. The additional claims relate to advantageous and preferred embodiments of the invention, which are explained in more detail below. In this context, some of the features are described only for the induction cooktop, only for the method, or only for the use. Nonetheless, they should be able to apply to an induction cooktop, to a method, and to a use independently of one another. The wording of the claims forms part of the content of the description by explicit reference.

The induction cooktop has a cooktop plate and a support structure, the support structure being formed in a planar and flat manner and having a flexible woven fabric as the planar and flat support having two surfaces, as well as antennas and/or sensors on the support. The antennas and/or the sensors, as the lines, are mounted and/or secured at least on one side or surface of the support by means of embroidering processes, which means that the lines are placed on the surface of the support and then overstitched or secured on the support by so-called cross-stitches that extend through the support. This is known from the prior art; see for example US 2016/302263 A1.

The antennas and/or the sensors have feed lines, these feed lines being mounted and/or secured on the support by means of an aforementioned embroidering process, the feed lines crossing each other and/or the lines of the antennas and/or the sensors on the same surface of the support and being electrically insulated from one another when doing so. This means that they can extend directly one on top of the other and contact each other when doing so, but advantageously are electrically insulated from one another and thus separated in terms of signals. The support structure has a thermal stability of at least 200° C., as a result of which it is possible to heat a pot or a pan to temperatures of around 300° C. or even higher on the induction cooktop, for example to brown food; this can lead to said temperature of at least 200° C. below the cooktop plate. It is for this reason that said thermal stability is provided according to the invention. The support structure is arranged on a planar and flat retainer, which can preferably be formed in a rigid manner, and, together with its antennas and/or sensors, is directly or indirectly pressed, advantageously resiliently pressed, against an underside of the cooktop plate by said retainer. A spring apparatus or the like can be provided for this. A retainer of this kind may be an induction heating coil itself, which is arranged, for example, in a plastics housing or between thin electrically insulating disks. Said plastics housing or the induction heating coil could thus be pressed against the cooktop plate using the aforementioned springs. Advantageously, the support structure is pressed against the cooktop plate directly on a side on which no antennas or sensors are arranged, and the antennas and sensors are not damaged. To improve the electrical safety, the support structure can also indirectly abut the cooktop plate through the insertion or interposition of an electrically insulating disk.

By using a support structure of this kind having an adequately thermally stable woven fabric, and thermally stable threads for securing the lines by means of embroidering, and thermally stable feed lines advantageously formed by electrically insulated wires, a versatile use can be provided.

In an advantageous development of the invention, at least one induction heating coil is arranged below the support structure for inductively heating a cooking vessel placed on the cooktop plate, as well as for wireless communication and/or for the aforementioned wireless transmission of energy to a load, as is known from the above-mentioned US 2022/255355 A1. Particularly advantageously, at least one antenna and/or at least one sensor extends, by less than its entire surface area, over the induction heating coil and/or projects beyond the induction heating coil sideways or radially outward at least in part. The antenna may even be smaller than the induction heating coil, i.e. preferably may not project beyond it.

In an embodiment of the invention, at least two antennas and/or sensors may be mounted on the same surface of the support, advantageously two antennas and two to four sensors, preferably three sensors. The sensors can be split such that they are present in part-sensors. Preferably, the sensors can also be formed as antennas or coils having part-surfaces. In an advantageous embodiment, all the antennas and sensors are mounted on the same surface of the support, in particular along with all their lines or feed lines.

In a further embodiment of the invention, the support may have at least one protruding region sticking out from the support, in particular at least three protruding regions sticking out from the support. A protruding region may be formed from the same continuous woven fabric of the support, such that the support advantageously has an area cut out from an entire piece, so as to produce an integral connection to the protruding regions. Advantageously, a portion of the feed lines and/or antennas and sensors is mounted and/or secured on the protruding region. In particular, said portion may be used to guide the feed lines in a manner clearly separated from the antennas and sensors. A protruding region may stick out from the outer edge of the support by a length of between 5% and 20%, it being possible for a width of a protruding region to be in particular between 30% and 20% of its length.

In a development of the invention, either only feed lines to the antennas, in particular to all the antennas, or only feed lines to a sensor, in particular to just one sensor, may be mounted and/or secured on a protruding region. This makes electrical isolation easier so that faults are less likely to occur.

In an advantageous development of the invention, the support may have a plurality of protruding regions for feed lines to the sensors in the outer region of the support, wherein particularly advantageously the protruding regions may be uniformly distributed.

In an embodiment of the invention, antennas or sensors can be arranged such that they overlap, advantageously in the regions in which two sensors are adjacent to one another. This makes them easier to use in an alternating manner. In addition, this overlapping, in particular in the case of the sensors, does not result in any regions of reduced sensitivity for detecting items, pots, or the like on the cooktop plate above the support structure.

Preferably, the feed lines are formed from uninterrupted wire, each wire preferably also forming at least one antenna or at least one sensor. Particularly preferably, a wire of this kind forms the feed lines to an antenna or to a sensor, and also the lines thereof themselves, i.e. also the antennas or the sensor, and advantageously in a continuous or uninterrupted manner. The effort required to establish electrical contact can be eliminated, and the overall electrical resistance is lower. In this case, the method for securing such virtually loose wires on the support structure can also advantageously be used for the actual electrical connection. For this purpose, the antennas and/or sensors and the feed lines can thus each be formed from a joint uninterrupted wire. In general, a wire in the form of a single conductor or wire, and thus not a multi-strand conductor, is preferably used.

In an advantageous embodiment of the invention, a wire, the wires, or all the wires may have a thermally stable lacquer as electrical insulation, as is known from coil winding. In this case, each wire, as a single-strand conductor, is preferably electrically insulated with respect to the exterior or other wires by means of a thermally stable lacquer, a lacquer of this kind in particular having a thermal stability of ≥200° C. The wire is thus as thermally stable as the support or the woven fabric thereof itself, i.e. also as thermally stable as the entire support structure.

Preferably, a diameter of the wire is 0.1 mm to 0.5 mm, preferably 0.15 mm to 0.25 mm. Advantageously, the diameters of all the wires for the antennas and sensors are the same, or overall just one type of wire is used. This makes production simpler. Preferably, the wires have a high-grade low-resistance configuration. They may in particular be copper wires.

In an advantageous development, at least one sensor and/or at least one antenna has, as a line, two wires extending in parallel, in particular the antennas. This means they can be configured in a low-resistance manner, or that the electrical resistance can be reduced. As an alternative, one slightly thicker wire having overall the same cross-sectional area as two thinner wires could be used, although said wire would then be more difficult to bend or more difficult to guide around radii or may only be laid in relatively large radii. In general, thick wires are not needed for the sensors anyway, in particular at said relatively low operating frequency. Advantageously, the feed lines may be formed in a twisted manner or in a crossing structure, either secured on the support in that manner by means of embroidering processes or extending in that manner at least outside the support. This can reduce the coupling of interference signals into the feed line.

Preferably, the antennas are configured as NFC antennas or RFID antennas, as is known from the prior art mentioned at the outset. For this purpose, they can be produced using a double wire made of the same material and of the same type, as described above. These NFC antennas are used so that the induction cooktop can communicate with a kitchen appliance that is placed thereon and configured for this purpose. The kitchen appliance may also be supplied with a limited electrical power via the NFC antenna, in order, for example, to power operating and display elements once said appliance has been set down. Thus, an operator control in the kitchen appliance for activating the power transmission is possible without needing an energy storage device, for example a battery or an accumulator.

Advantageously, the sensors are configured as so-called FOD sensors, which are configured in a planar manner and which are also known as pot detection sensors according to US 2016/302263 A1 for detecting objects or items on the cooktop plate above the support structure. Using these sensors, it can be checked whether prohibited foreign objects are located on the placement surface in the operating range of the inductor or induction heating coil for the energy transmission (“foreign object detection”). In this case, the detection of the foreign object is reported to the induction cooktop and a power demand for energy to be transmitted is denied. In this case, the FOD sensors are in particular configured as coils and are preferably formed from a single wire, unlike the above-described antennas.

In a development of the invention, it can be provided that adjacent FOD sensors overlap and the lines thereof intersect when doing so. Advantageously, the FOD sensors can be configured in the form of circular segments and can in particular be of the same type and the same size. Preferably, the support structure may have four to eight, in particular six, FOD sensors per induction heating coil, two FOD sensors in each case being electrically interconnected by their sensor surfaces and being electrically connected outwardly using two feed lines; they thus form a joint sensor as part-sensors, as it were. The two FOD sensors or sensor surfaces are preferably opposite one another. Advantageously, the interconnected FOD sensors have opposite winding directions such that the action of the penetrating magnetic field of the induction coil is mutually compensated for in the FOD sensors or sensor surfaces. Precisely one first feed line runs toward the support and on the woven fabric thereof and forms thereon an FOD sensor as a part-sensor in the form of a coil running from the outside inward. It then extends through the center region of the support toward the opposite region of the support and forms the other FOD sensor as a part-sensor in the form of a coil running from the inside outward; it then runs away from the support as the other, second feed line next to the first feed line. In this case, said first feed line and said second feed line can extend outward from the center region in parallel and next to one another spaced apart slightly by 1 mm to 5 mm. Thus, in general, the feed lines to the FOD sensors may first extend into the center region of the support from radially outside, and then away from said support toward the FOD sensors. In this case, it may preferably be provided that, on the way from the outside into the center region of the support, the feed lines do not overlap the FOD sensors that they themselves form. This makes faults less likely.

In a further embodiment, the additional mounting of FOD sensors is omitted, i.e. only antennas, in particular NFC antennas, are provided. In this case, a measured impedance at the NFC antenna or an attenuation measurement over the induction coil can be alternatively used as an FOD sensor. While this reduces the sensitivity to detecting foreign objects (FOD), it also reduces the effort required for detecting foreign objects (FOD) on the cooktop.

As already indicated above, it may advantageously be provided that an electrical connection of wires extending in parallel toward the antennas and/or sensors is electrically connected in the region of a connection to a controller. This means that these wires or feed lines extend from the support structure in a continuous and uninterrupted manner, in particular not even interrupted by a plug connection or the like, toward an electrical connection to the controller, for example on a printed circuit board on which a control system forming the controller is arranged, and are plugged or screwed only thereon.

In an advantageous development of the invention, the feed lines stick out from the support structure and run further, in an uninterrupted manner, as a connection to a controller. In this case, they may have a length of at least 20 cm, in particular a length of at least 50 cm. In an induction cooktop, this should be adequate to reach from an induction heating apparatus as far as a controller or printed circuit board having the controller thereon.

In a possible embodiment of the invention, an electrical insulation, in particular a planar electrical insulation, may be provided between the support structure having the feed lines and antennas and/or sensors on the one hand, and the underside of the cooktop plate on the other hand. Advantageously, an electrical insulation of this kind is a structural unit that can be handled independently or can be formed by the support itself in that the support, as the electrical insulation, abuts the underside of the cooktop plate by an underside on which no feed lines, antennas and/or sensors are mounted and/or secured. A structural unit that can be handled independently as the electrical insulation might be a thin disk made of mica or glimmer.

To be able to produce an above-described induction cooktop, the following steps can be carried out. First, a flexible woven fabric is provided as a planar and flat support having two surfaces, which are opposite one another. Antennas and/or sensors are mounted and/or secured on one side or surface of the support at least by means of embroidering processes, i.e. a wire or line in order to form said antennas and/or sensors. In addition, bonding may possibly be used as preliminary securing or pre-fixing. Bonding is not as effective for permanent securing owing to the high desired thermal stability. Feed lines for the antennas and/or the sensors are also mounted and/or secured on the support by means of embroidering processes, in particular identical processes to those for the antennas and/or sensors. In this case, the feed lines can be crossed with each other and/or with the antennas and/or with the sensors on the same surface of the support and are electrically insulated from one another when doing so. In this case, at least two antennas and/or sensors may be mounted on the same surface of the support. Advantageously, all the antennas and/or sensors, in particular all the electrically conductive parts, are mounted on a single surface of the support whereas the other surface of the support is free of them.

During the mounting, the feed lines may be twisted or also secured on the support in a crossing structure by means of embroidering processes. More particularly, they may be twisted as soon as they leave the support and are no longer secured thereon. As described above, this helps to reduce the coupling of interference signals into the feed line.

In a further embodiment of the method according to the invention, it is possible for at least one feed line to be detached from the protruding region again and laid elsewhere once the support structure is complete. When said feed line is laid elsewhere, it is advantageously no longer secured on the support or on the support structure by embroidering but in particular is placed back on the support or the support structure. Alternatively, it may also be secured on the support again. In this case, a feed line can be guided as far as a connection region of the support, from where a plurality of feed lines to the antennas and/or sensors are guided away outward. In this case, it may also be provided that one or more feed lines are guided through a hole in the support and, as it were, extend on the other side or surface of the support.

An above-described support structure can be used for an induction cooktop, the induction cooktop having a device for wirelessly transmitting energy toward an electrical load on the induction cooktop by means of inductive coupling, i.e. WPT as mentioned at the outset. In this case, an induction heating coil of the induction cooktop is preferably used as the device for wirelessly transmitting energy, for example to a kitchen appliance placed on top of said coil on a cooktop plate. Said antennas allow the induction cooktop to communicate with the kitchen appliance, in particular by means of NFC. Advantageously, an induction heating coil is briefly switched off so that said near-field communication can take place. The two magnetic fields thus do not interfere with one another. Said sensors are used for detecting on the cooktop plate items or objects that are neither a suitable kitchen appliance to be inductively supplied with energy, nor a pot to be directly inductively heated.

For the basics of WPT, reference is made to the relevant technical literature and US 2022/255355 A1 mentioned at the outset. Preferably, the induction cooktop is operated in accordance with the WPC (Wireless Power Consortium) Ki (Cordless Kitchen) method. In this context, an induction heating coil of the induction cooktop can be used for wirelessly transmitting energy to an electrical load, for example to a kitchen appliance, such as a mixer or the like, placed on a cooktop plate. Indeed, a power of the energy transmission can be in the range of 200 W to 2.2 kW on the secondary side. At the same time, the induction cooktop may communicate with the kitchen appliance; for this purpose, an NFC method or near-field communication is preferred, as is known from DE 10 2021 212 550 A1, which is thus referred to by explicit reference.

These and other features emerge from the description and the drawings, in addition to the claims; the individual features can be implemented in themselves either alone or severally in the form of sub-combinations in one embodiment of the invention and in other areas, and can constitute advantageous embodiments that are eligible for protection in themselves and for which protection is sought here. The subdivision of the application into individual sections and sub-headings does not limit the statements made thereunder in terms of their general applicability.

### BRIEF DESCRIPTION OF THE DRAWINGS

Further advantages and aspects of the invention can be found in the claims and in the description of embodiment examples of the invention, which are explained below on the basis of the drawings, in which:

FIG. 1 is a sectional view through a cooktop according to the invention comprising an induction heating apparatus, an antenna support, and a cooktop plate,

FIG. 2 is a plan view of the equipping side of the antenna support, showing the structure of NFC antennas and of FOD sensors,

FIG. 3 is an enlarged view of a portion of the antenna support from FIG. 2,

FIG. 4 is another enlarged view of a detail of the illustration from FIG. 3, with lines laid in parallel for the NFC antennas and lines laid singly for the FOD sensors.

### DETAILED DESCRIPTION OF THE EMBODIMENT EXAMPLES

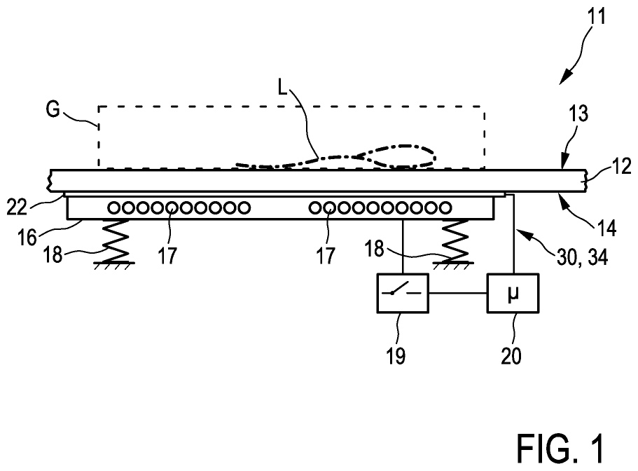

FIG. 1 is a simplified side view of a cooktop 11 according to the invention as an induction cooktop. In principle, the construction of induction cooktops of this kind is well known; reference is made to US 2016/302263 A1. The cooktop 11 has a cooktop plate 12 having a top side 13 and an underside 14. An induction heating apparatus 16 underneath the cooktop plate 12 defines a cooking area in a known manner. A plurality of such induction heating apparatuses 16 can be coupled together during operation in order to create a larger cooking area for very large cooking vessels, for example roasting pans or the like. The induction heating apparatus 16 has an induction heating coil 17, which is illustrated by its windings in one plane.

A converter 19, which can also be regarded as a rectifier and inverter, is schematically shown for activating and supplying power to the induction heating apparatus 16 or the induction heating coil 17. The converter 19 is connected to a controller 20 for the entire cooktop 11 and receives commands therefrom. In particular, the controller 20 is also connected to an operator apparatus (not shown) of the cooktop 11 for inputting operating commands.

A flat and planar antenna support 22 is arranged between the induction heating apparatus 16 and the underside 14 of the cooktop plate 12. As can be seen from FIG. 1, the antenna support 22 is, as it were, pressed against the underside 14 of the cooktop plate 12 by the induction heating apparatus 16 so as to thus ensure that it securely abuts the cooktop plate. Springs 18 are shown schematically for this purpose. Thus, said antenna support does not require separate securing, and it is possible to configure it so that it is flexible and non-rigid, as mentioned at the outset, yet also stable and secure. It can be seen that the antenna support 22 reaches as far as the outer edge of the induction heating apparatus 16, or may even protrude slightly beyond it. It is thus clear that it, and antennas and/or sensors arranged thereon, projects sideways beyond the outer edge or surface cover of the induction heating coil 17, advantageously by 1 cm to 2 cm. This is advantageous for reliably detecting items in the active area of the induction heating coil 17.

In a further possible embodiment of the invention, the antenna support 22 may also rest on a flexible layer of electrically and thermally insulating material that extends over the induction heating coil 17 and covers the top side thereof. A flexible layer of this kind may have a thickness of 1 mm to 5 mm.

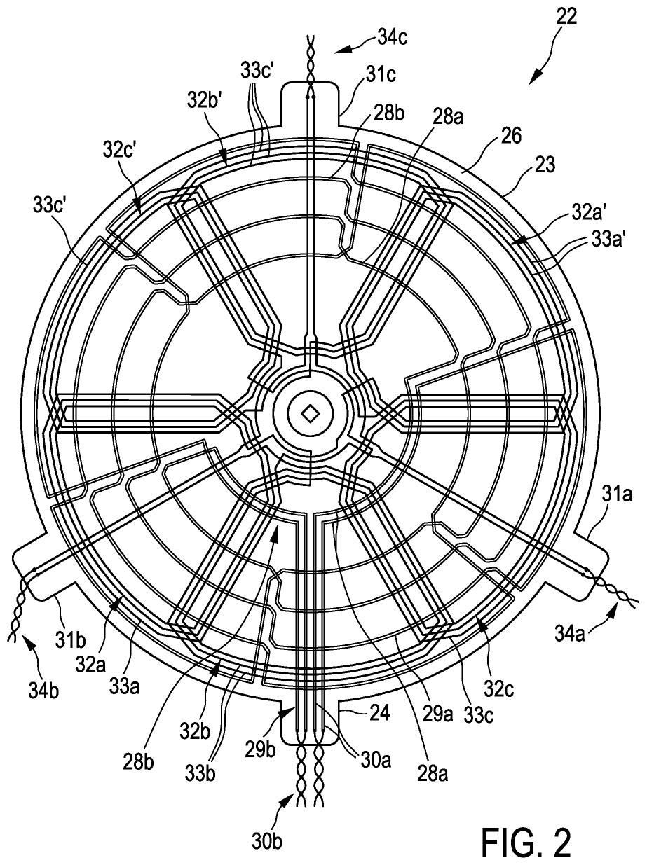

For the functioning of the cooktop 11, in one operating option it is provided to heat an appliance G (shown in dashed lines) by operating the induction heating coil 17 underneath it in a known manner when said appliance G is, for example, a normal cooking pot, i.e. to inductively heat it. Depending on the specified power, the induction heating coil 17 is then operated at a relatively high electrical power, for example 2.2 kW or even 3.6 kW. If, in a different operating option in line with an induction cooktop mentioned at the outset, an appliance or cooking pot is not inductively heated but rather a so-called countertop appliance, for example a stand mixer, is operated using inductively transmitted power, this is also done by means of power transmitted by the induction heating coil 17 using an alternating magnetic field. This corresponds to the operating option as WPC or Ki power transmission. In this case, the total power can be less than as described above, but a significant power is transmitted in any case. Since communication with the countertop appliance is also intended as standard for this function, the cooktop 11 has the antenna support 22, which is equipped with two NFC antennas 28a and 28b according to the illustration in FIG. 2. There is not much to explain about this type of communication; reference is made to the cited or known prior art. The precise structure of the antenna support 22 will be explained further below.

In addition, however, it is also important to be able to sense which type of appliance or item has been placed above the induction heating apparatus 16. In known induction cooktops on the market, so-called pot detection sensors are provided, which are often configured as inductive sensors that can sense the location and also an approximate type of an item on the cooktop plate 12, at least when said item is metal and can be inductively heated. Specifically, if a metal spoon L (shown in dashed lines) is located above the induction heating apparatus 16, this should be detected and power has to be prevented from being supplied to the induction heating coil 17. A spoon L of this kind is clearly not intended to be heated, and an operator should accordingly be notified of a fault. This is also referred to as FOD (foreign object detection); to detect any such item, the antenna support 22 has a plurality of FOD sensors 32. Specifically, it has three FOD sensors 32a to 32c, each FOD sensor having two part-surfaces that are electrically interconnected. These part-surfaces are shaped approximately like a circular segment and are each opposite one another. This will also be discussed in greater detail below. For instance, a relatively small object, for example a spoon L, and potentially even the position thereof, above the induction heating apparatus 16 can be detected relatively reliably. This also works in an inductive manner, as with the above-mentioned pot detection sensors, so the FOD sensors 32a to 32c can also be regarded as antennas. However, they are intended merely for sensing something, not for enabling any communication. Whereas the NFC antennas 28 operate at a high frequency of more than 10 MHz, so as to also ensure sufficient communication or information transfer, the FOD sensors 32 can be operated at a considerably lower frequency. For example, they can be operated at less than 250 kHz, preferably at approximately a working frequency of the induction heating coil 17, which is less than or equal to 75 kHz. Both the NFC antennas 28 and the FOD sensors 32 are connected to the controller 20 by means of feed lines 30, 34 for the purposes of actuation and evaluation.

In the plan view of an equipping side 26 of the antenna support 22, it can be seen that the antenna support is a substantially round support 23. Advantageously, it consists of a flexible woven fabric mentioned at the outset, and advantageously of a glass fiber woven fabric or the like, which is flexible and non-rigid. The antenna support 22 is equipped or fitted with lines only on the equipping side 26 and not on the other side. The equipping uses wires as lines, as will be described in more detail below. In addition, it is possible to secure and electrically connect other components, in particular small components, for example SMD components, on the support 23. In this regard, reference is made to the cited US 2016/302263 A1.

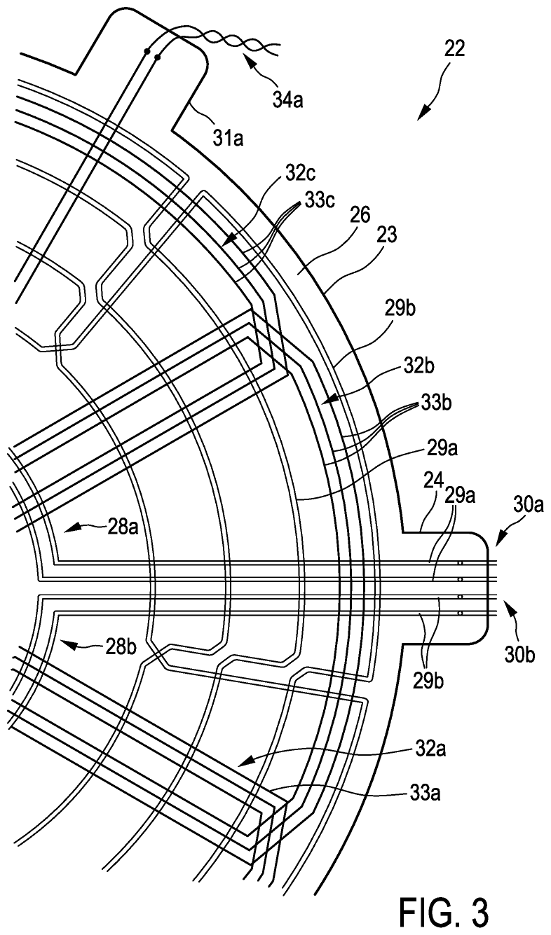

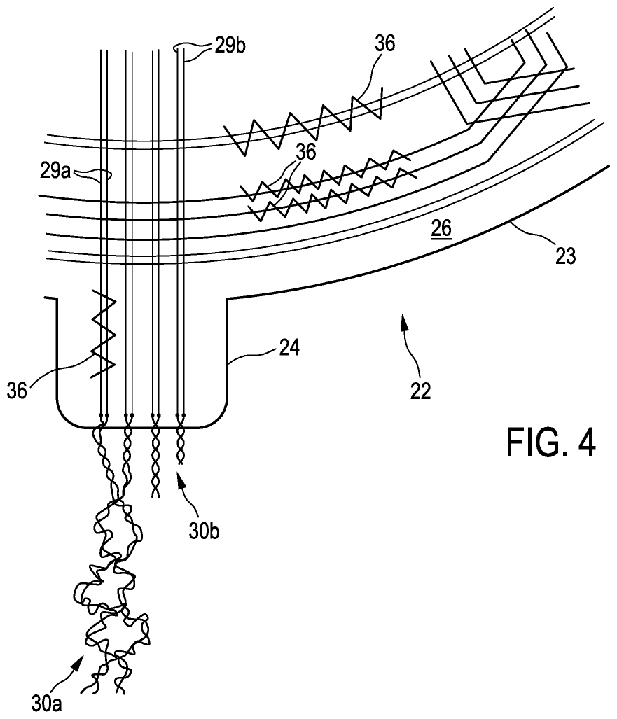

The NFC antennas 28a and 28b are formed by lines 29a and 29b, which are thin wires. Advantageously, these wires consist of copper having a diameter of 0.2 mm and are high-grade or have a low electrical resistance. They have an insulation (known for such wires) by means of an insulating lacquer, so they are electrically insulated externally and can extend next to one another without shorting. More particularly, they can also thus cross each other, as explained at the outset. The laying pattern of the lines 29a and 29b, or the wires thereof, for the NFC antennas 28a and 28b is rather complex, as can be seen in FIG. 2, but both NFC antennas 28a and 28b substantially extend around the support 23, with the radius varying or jumping in steps. Feed lines 30a and 30b are laid on a protruding region 24, which sticks out downward from the outside of the support 23 and is, as it were, an extension of the corresponding woven fabric. This can also be seen in an enlarged view in FIGS. 3 and 4. In this case, therefore, the corresponding lines 29a and 29b are led in and, as soon as they extend on the support 23, they are fixed by means of overstitches 36 as per FIG. 4. It can be seen in FIG. 4 that the lines 29 for the NFC antennas 28a and 28b are, as it were, doubled or consist of wires guided in twos, the wires being identical. The advantage of this is that the electrical resistance is lower, specifically also because of the aforementioned high frequencies. The advantage of using two parallel lines 29 instead of a single wire having a thicker cross section or greater wire diameter is that these thinner lines can be laid in tighter radii. While the lines 29 can each be secured individually by means of overstitches 36, they can advantageously be led in in twos and overstitched. In this case, it is not absolutely necessary for them to always extend in parallel; they can also cross at some points.

The enlarged view of FIG. 4 also shows that, for example, the lines 29a and 29b for the NFC antennas 28a and 28b consist of the double wires extending closely next to one another and are guided directly from the main region of the support 23 as far as the protruding region 24 and secured by means of the overstitches 36. In this case, each line 29a and 29b or the double wires are each individually overstitched, in order to also keep them apart effectively. The overstitch 26 stops just before the outer end of the protruding region 24, and the double wires can be twisted together but they need not be. To then form the freely extending feed lines 30a and 30b, each line of an NFC antenna 28 can be twisted together again so as to reduce interference. Lastly, the feed lines 30a and 30b can also be twisted together but they need not be. Likewise, they can be provided with a type of loose casing, for example an insulating plastics sheath, which also protects them from damage. However, this is known per se from the prior art. These feed lines 30a and 30b can then have a length of up to 40 cm or 50 cm and be guided directly to a connection, in particular to the controller 20. Alternatively, they can be connected to such an electrical connection on a component support or on a printed circuit board on which the controller 20, or a control system forming it, is also arranged. No further electrical contact then needs to be provided.

The more detailed configuration of the FOD sensors 32a to 32c can be seen in FIGS. 2 and 3. Each FOD sensor 32 consists of a type of coil having three windings formed approximately in the manner of a trapezoid or circular segment. The overlap between adjacent FOD sensors 32 is clearly visible, and indeed in its entirety. It can also be seen that the three wires guided in parallel as the lines 33 are bent not by 90° but by larger angles, in particular so as to guide the wires more effectively and also to prevent two bends of different FOD sensors 32 being exactly opposite one another in the overlap regions too often. In this case, the feed lines 34 extend from the exterior toward respective protruding regions 31a to 31c, outside which they can be twisted, as shown in FIGS. 2 and 3 for the feed lines 34a. In this case, the feed lines 34a stick out by a similar length to the feed lines 30 of the NFC antennas 28 and are electrically connected in the same way. As soon as they are on the support 23 or a protruding region 31, they are secured by means of overstitches 36. The feed lines then first run once into the center region of the support 32, from where they then each run toward the opposite part-FOD sensor 32a to 32c and 32a′ to 32c′, which are then interconnected in turn. This ensures that the feed lines 34, when coming from outside into the center region, cannot cross over any FOD sensors whose electrical connection they themselves form.

Another option for electrically connecting the FOD sensors 32 and the NFC antennas 28 would be if all the feed lines 30 and 34 were guided back inward into the center region from the outer protruding regions 24 and 31. Here, a central hole could be provided in the support 23, through which said feed lines are guided and are then guided away on the opposite side to the equipping side 26. In addition, they could then be guided as a type of joint cable strand, thereby simplifying the guidance and electrical connection thereof, in particular when assembling the cooktop 11.

According to FIG. 1, it is advantageously provided that the antenna support 22 is placed between the cooktop plate 12 and induction heating apparatus 16 in such a way that the equipping side 26 comprising the entire conductor structure faces downward, i.e. toward the induction heating apparatus 16. The advantage of this is that the electrically insulating opposite side of the antenna support 22, on which advantageously no lines extend, then abuts the underside 14 of the cooktop plate 12. Thus, a necessary and advantageous electrical insulation with respect to the cooktop plate 12 is immediately achieved. Additional electrical insulation, for example a thin mica plate or the like, is no longer needed.

In the center region of the support 23, a temperature sensor could also be arranged, which is configured as an aforementioned separate component. A feed line secured by overstitching could extend over led-in lines or wires, for example over one of the protruding regions 24 or 31.

Advantageously, an antenna support 22, as well as a thread for the embroidering, is readily thermally stable up to 200° C. owing to the materials used. The wires, as lines or feed lines, are fitted with an accordingly thermally stable insulating lacquer. In addition, the wires are provided in a continual manner such that they form the feed lines and the corresponding NFC antennas 28 and FOD sensors 32 in a continuous and uninterrupted manner.

1. An induction cooktop comprising a cooktop plate and a support structure, wherein said support structure is formed in a planar and flat manner and has:
a flexible woven fabric as a planar and flat support having two surfaces,
antennas and/or sensors on said support, wherein said antennas and/or said sensors are mounted or secured as lines at least on one side or on one surface of said support by means of embroidering processes,
said antennas and/or said sensors have feed lines, wherein said feed lines are mounted or secured on said support by means of embroidering processes, wherein said feed lines cross each other or said lines of said antennas and/or said sensors on said same surface of said support and are electrically insulated from one another when doing so,
a thermal stability of ≥200° C.,
wherein said support structure is arranged on a planar and flat retainer and thus, together with said antennas and/or said sensors, directly or indirectly abuts an underside of said cooktop plate.

2. The induction cooktop according to claim 1, wherein at least one induction heating coil for inductively heating a cooking vessel placed on said cooktop plate is arranged below said support structure, at least one said antenna and/or at least one said sensor extending, by less than an entire surface area, over said induction heating coil or projecting beyond said induction heating coil sideways or radially outward at least in part.

3. The induction cooktop according to claim 1, wherein at least two said antennas and/or said sensors are mounted on said same surface of said support.

4. The induction cooktop according to claim 1, wherein said support has at least one protruding region sticking out from said support, said protruding region being formed from said same continuous woven fabric as of said support, a portion of said feed lines or said antennas or said sensors being mounted or secured on said protruding region.

5. The induction cooktop according to claim 4, wherein either only feed lines to said antennas or only feed lines to one said sensor are mounted or secured on one said protruding region.

6. The induction cooktop according to claim 4, wherein said support has a plurality of said protruding regions for said feed lines to said sensor in an outer region of said support, one said protruding region sticking out from an outer edge of said support by a length of between 5% and 20%.

7. The induction cooktop according to claim 1, wherein said antennas or said sensors are arranged so as to overlap in order to be used in an alternating manner.

8. The induction cooktop according to claim 1, wherein said feed lines or said antennas and/or said sensors are formed from uninterrupted wire and form said lines of said antennas and/or said sensors.

9. The induction cooktop according to claim 8, wherein said antennas and/or said sensors and said feed lines are each formed from joint uninterrupted wire, said wire being a single conductor and not a multi-strand conductor.

10. The induction cooktop according to claim 8, wherein said wire has a thermally stable lacquer coating as electrical insulation, said lacquer coating having a thermal stability of at least 200° C.

11. The induction cooktop according to claim 1, wherein at least one said sensor and/or at least one said antenna has, as a line, two said wires extending in parallel.

12. The induction cooktop according to claim 1, wherein said feed lines are twisted or are secured on said support in a crossing structure by means of said embroidering processes, so as to reduce said coupling of interference signals into said feed line.

13. The induction cooktop according to claim 1, wherein said antennas are formed as NFC antennas or RFID antennas.

14. The induction cooktop according to claim 1, wherein said sensors are formed as FOD sensors for detecting objects or items on said cooktop plate above said support structure, said FOD sensors being formed as coils formed by a single wire.

15. The induction cooktop according to claim 14, wherein adjacent of said FOD sensors overlap and said lines thereof cross each other when doing so, said FOD sensors being configured in a form of circular segments and being of same type and same size.

16. The induction cooktop according to claim 14, wherein said support structure has four to eight of said FOD sensors per one said induction heating coil, and in each case two said FOD sensors are electrically interconnected and are electrically connected outwardly using two of said feed lines, said two FOD sensors being wound in opposite directions, each of said two FOD sensors being opposite one another.

17. The induction cooktop according to claim 14, wherein precisely one first feed line for said FOD sensors runs toward said support, forms one said FOD sensor thereon as a coil running from an outside inward, then extends through a center region of said support toward an opposite region of said support and forms said other FOD sensor as a coil running from an inside outward, and then extends from said support as an other, second feed line next to said first feed line.

18. The induction cooktop according to claim 1, wherein an electrical connection of said wires extending in parallel is electrically connected in a region of a connection to a controller.

19. The induction cooktop according to claim 1, wherein said feed lines stick out from said support structure and run further, in an uninterrupted manner, as a connection to a controller.

20. The induction cooktop according to claim 1, wherein an electrical insulation is provided between said support structure having said feed lines and said antennas and/or said sensors and said underside of said cooktop plate, said electrical insulation being a structural unit that can be handled independently or is formed by said support itself in that said support, as said electrical insulation, abuts said underside of said cooktop plate by an underside on which no said feed lines and no said antennas or said sensors are mounted.

21. A method for producing a support structure for said induction cooktop according to claim 1, comprising the steps of:
providing a flexible woven fabric as a planar and flat support having two surfaces,
mounting or securing antennas and/or sensors at least on one side or surface of said support by means of embroidering processes,
mounting or securing feed lines for said antennas and/or said sensors on said support by means of embroidering processes, wherein said feed lines cross each other or said antennas and/or said sensors on said same surface of said support and wherein said feed lines are electrically insulated from one another when doing so.

22. The method according to claim 21, wherein at least two said antennas and/or said sensors are mounted on said same surface of said support.

23. The method according to claim 21, wherein said feed lines are twisted or are secured on said support in a crossing structure by means of embroidering processes, so as to reduce coupling of interference signals into said feed line.

24. The method according to claim 21, wherein at least one said feed line to at least one said antenna and/or to at least one said sensor is mounted or secured on a protruding region.

25. The method according to claim 24, wherein, once said support structure is complete or finished, said at least one feed line is detached from said protruding region again and is placed back on said support or said support structure and is also secured thereon.

26. Use of a support structure for an induction cooktop, wherein said support structure is formed in a planar and flat manner and has:
a flexible woven fabric as a planar and flat support having two surfaces,
antennas and/or sensors on said support, wherein said antennas and/or said sensors are secured at least on one side or surface of said support by means of embroidering processes,
said antennas and/or said sensors have feed lines, wherein said feed lines are mounted or secured on said support by means of embroidering processes, wherein said feed lines cross each other or said antennas and/or said sensors on said same surface of said support and are electrically insulated from one another when doing so,
a thermal stability of ≥200° C.,
wherein said support structure is arranged on a planar and flat retainer and, together with said antennas and/or said sensors, directly or indirectly abuts an underside of said cooktop plate,
wherein said induction cooktop has a device for wireless communication or for wirelessly transmitting energy toward an electrical load on said induction cooktop by means of inductive coupling, wherein an induction heating coil of said induction cooktop is used as said device for wireless communication or for wirelessly transmitting energy.
